(19) United States
(12) Patent Application Publication
(10) Pub. No.: US 2006/0189724 A1
(43) Pub. Date: Aug. 24, 2006

(54) Anaerobically curable composition

(75) Inventor: Mitsuhiro Kaneta, Hachiojo-shi (JP)

Correspondence Address: SUGHRUE MION, PLLC, 2100 PENNSYLVANIA AVENUE, N.W., SUITE 800, WASHINGTON, DC, 20037, US

(73) Assignee: THREE BOND CO., LTD.

(21) Appl. No.: 10/565,553

(22) PCT Filed: Jul. 22, 2004
(86) PCT No.: PCT/JP04/10770

§ 371 Date: Jan. 23, 2006

(30) Foreign Application Priority Data
Jul. 25, 2003 (JP) 2003-279578
Oct. 28, 2003 (JP) 2003-368853

(51) Int. Cl. C08K 5/46

(52) U.S. Cl. 524/83; 524/413; 524/435

(57) ABSTRACT

The invention is concerned with an anaerobic curable composition containing (a) a compound having at least one radically polymerizable functional group in its molecule thereof, (b) an organic peroxide, (c) o-benzoic sulfimide, and (d) a complex of a metal other than alkali metals and ethylenediaminetetraacetic acid, or a complex of a metal other than alkali metals and diethylenetriaminepentaacetic acid. According to the invention, it is possible to provide an anaerobic curable composition capable of largely improving a setting time against an inert metal, while keeping preservability of the anaerobic curable composition.

### FIELD OF THE INVENTION

The present invention relates to an anaerobic curable composition capable of largely improving a setting time when an inert metal is used as an adherend, while keeping preservability similar to conventional anaerobic curable compositions.

### BACKGROUND ART

An anaerobic curable composition contains a (meth)acrylic acid ester monomer as the major component and has such properties that during the time when it comes into contact with air or oxygen, it is kept stably in its liquid state without causing gelation over a long period of time, whereas when air or oxygen is blocked off or excluded, it is rapidly cured. Utilizing such properties, the foregoing composition is used in bonding or fixing of screws, bolts, etc., fastening of fitting parts, bonding or sealing between flange planes, filling of cavities formed in cast parts, and the like.

When a curable composition is coated on an adherend, followed by lamination, air or oxygen is blocked off or excluded. An anaerobic curable composition is cured by this blocking or exclusion of air or oxygen. At this time, the setting time differs depending upon the material of an adherend even among anaerobic curable compositions having the same formulation. This is because an anaerobic curable composition itself is reduced when it oxidizes a metal serving as the adherend and is cured by this chemical reaction, so that the setting time differs depending upon the material of the adherend. In particular, in an adherend having been subjected to an antioxidant treatment, such as bright chromate and green chromate, since the amount of active metal ions present on the surface of the adherend is small, it has a low ability to react an anaerobic curable composition so that the setting time becomes remarkably slow. For the sake of rapidly bonding such an adherend, it is considered important that the surface of the adherend is oxidized rapidly as far as possible. In general, there are used anaerobic curable compositions designing to improve the setting time by adding purified water in the composition, using a monomer having a carbonyl group, or adding a chain transfer agent to enhance the reactivity itself of the composition. These are described, for example, in Patent Document 1 and Patent Document 2.

Patent Document 1: JP-B-2-44345

Patent Document 2: JP-B-48-9460

However, even in the foregoing anaerobic curable compositions, a difference in the setting time due to the difference of the material of an adherend is large, and in particular, anaerobic curable compositions having excellent preservability and capable of rapidly curing inert metals have not been obtained yet.

Now, since the anaerobic curing mechanism is basically radical polymerization using an organic peroxide as an initiator, the organic peroxide is decomposed by a metal ion so that the reaction starts. For this reason, when a metal ion is made present in an anaerobic curable composition, gelation is caused. Accordingly, a copper ion and a vanadium ion cannot be made present in the composition, and it was impossible to add them in the composition beforehand.

As described above, though anaerobic curable compositions capable of rapidly curing even inert metals without sacrificing the storage stability have been demanded, satisfactory compositions have not be obtained yet.

### DISCLOSURE OF THE INVENTION

An object of the invention is to overcome the foregoing problems of the conventional art and to provide an anaerobic curable composition having enhanced rapid curing property against inert metals while keeping preservability similar to the conventional anaerobic curable compositions. Specifically, the invention provides an anaerobic curable composition comprising (a) a compound having at least one radically polymerizable functional group in its molecule thereof, (b) an organic peroxide, (c) o-benzoic sulfimide, and (d) a complex of a metal other than alkali metals and ethylenediaminetetraacetic acid, or a complex of a metal other than alkali metals and diethylenetriaminepentaacetic acid.

### BEST MODE FOR CARRYING OUT THE INVENTION

The compound having at least one radically polymerizable functional group in its molecule thereof (component (a)), which is used in the invention, is one described as follows. First of all, examples of the radically polymerizable functional group as referred to herein include an acryloyl group, a (meth)acryloyl group, a vinyl group, and a propenyl group. A compound having such a functional group is generally called a radically polymerizable monomer, and examples thereof include methyl (meth)acrylate, ethyl (meth)acrylate, butyl (meth)acrylate, 2-ethylhexyl (meth)acrylate, phenyl (meth)acrylate, benzyl (meth)acrylate, 2-hydroxyethyl (meth)acrylate, 2-hydroxypropyl (meth)acrylate, tetrahydrofurfuryl (meth)acrylate, styrene, α-methylstyrene, and divinylbenzene. Incidentally, the term “(meth)acryl” as referred to herein is an inclusive term for acryl and methacryl.

As a compound having two or more radically polymerizable functional groups, so-called radically polymerizable polyfunctional monomers in which two or more radically polymerizable functional groups are present in the molecule of a relatively low molecular compound and so-called radically polymerizable oligomers having radically polymerizable functional groups in the both terminals or the like of a relatively high molecular compound are enumerated. Examples of the radically polymerizable polyfunctional monomers include ethylene glycol diacrylate, polyethylene glycol di(meth)acrylate, neopentyl glycol di(meth)acrylate, trimethylolpropane tri(meth)acrylate, pentaerythritol tetraacrylate, dipentaerythritol poly(meth)acrylate, and tetramethylolmethane tetra(meth)acrylate.

Examples of the radically polymerizable oligomers include epoxy-modified (meth)acrylates obtained by reacting acrylic acid, methacrylic acid or a polymer thereof with an epoxy group of a glycidyl ether such as bisphenol; urethane bond-containing (meth)acrylates obtained by reacting a hydroxyl group-containing (meth)acrylate with a terminal isocyanate group-containing compound; compounds resulting from reaction of a (meth)acryloyl group in the terminal of a polyether resin; and compounds resulting from reaction of a (meth)acryloyl group in the terminal of a polyester.

These compounds may be used singly or as a mixture of a plural number of the compounds for the purpose of adjusting the viscosity of the anaerobic curable composition or adjusting characteristics of its cured product. Usually, since it is difficult to reveal desired properties by a single use, it is preferable that a radically polymerizable monomer and a radically polymerizable oligomer are mixed and used.

The organic peroxide (component (b)) that is used in the invention is one which has hitherto been used in anaerobic curable compositions and is not particularly limited. Examples thereof include organic peroxides including hydroperoxides such as cumene hydroperoxide, t-butyl hydroperoxide, and p-menthane hydroperoxide; diallyl peroxides such as dicumyl peroxide, t-butylcumyl peroxide, and di-t-butyl peroxide; ketone peroxides such as methyl ethyl ketone peroxide, cyclohexane peroxide, and methylcyclohexane peroxide; diacyl peroxides such as benzoyl peroxide, lauroyl peroxide, and acetyl peroxide; peroxyesters such as t-butyl peroxybenzoate, t-butyl peroxyacetate, and t-butyl peroxymaleate.

These organic peroxides can be used singly or as a mixture of two or more thereof. The blending amount of this component (b) is generally from 0.1 to 5 parts by weight based on 100 parts by weight of the total weight of the component (a). When the blending amount is less than 0.1 parts by weight, it may possibly be insufficient to cause the polymerization reaction, whereas when it exceeds 5 parts by weight, the stability of the anaerobic curable composition may possibly be deteriorated.

The component (c) that is used in the invention is o-benzoic sulfimide and is a component usually used in anaerobic compositions. The o-benzoic sulfimide is so-called saccharin. Referring to the addition amount, the component (c) is usually blended in an amount of from 0.1 to 5 parts by weight based on 100 parts by weight of the component (a).

The component (d) that is used in the invention is a complex of a metal other than alkali metals with ethylenediaminetetraacetic acid (EDTA) or diethylenetriaminepentaacetic acid (DTPA). In the case where the metal that forms a complex is an alkali metal, the effect of the invention is not obtained. Actually, there are many metals capable of forming a complex with ethylenediaminetetraacetic acid or diethylenetriaminepentaacetic acid, which include metals that are suitable in the invention and metals that do not reveal the effect unless otherwise added in a large amount. Examples of metals that are suitable in the invention include Mg, Ca, Ti, V, Cr, Mn, Fe, Co, Ni, Cu, Zn, Al, and Ag. Now, ethylenediaminetetraacetic acid and diethylenetriaminepentaacetic acid are known as a metal chelating agent. When a metal ion is present in an anaerobic curable composition, the storage stability is deteriorated for the reason as described previously. The metal ion may be incorporated during the manufacture step or be present in a raw material itself. However, the addition of a metal chelating agent gives rise to an effect such that it captures the metal ion and keeps the ion in its inert state, thereby enhancing the storage stability. Though ethylenediaminetetraacetic acid and triethylenetetraminehexaacetic acid are used as this chelating agent, these compounds have been conventionally used in the form of a simple body but not a metal complex, or in the form of a sodium salt. However, even by adding only ethylenediaminetetraacetic acid or diethylenetriaminepentaacetic acid, each not in the form of a complex, or by adding only a sodium salt thereof, the action and effect of the invention are not exhibited at all.

It had been considered that metal ions such as Cu and Fe are to be excluded from an anaerobic curable composition, and hence positive addition thereof has not been investigated. However, in the case where an organic peroxide and a metal ion are stored in separate containers as seen in two-liquid mixing curable SGA adhesives, the metal ion can be positively used since the storage stability is not influenced thereby. However, when these metal ions are used in a one-liquid anaerobic curable composition, gelation instantly occurs so that a practically useful curable composition cannot be obtained.

Also, the metal complex of ethylenediaminetetraacetic acid or the metal complex of diethylenetriaminepentaacetic acid of the invention may not be a complex with only one metal ion. Also, the ethylenediaminetetraacetic acid and diethylenetriaminepentaacetic acid for use in the metal complex may be salts such as those with sodium or potassium. That is, the metal complex of the present invention may be a complex of such a salt with a metal ion (e.g., a complex of disodium ethylenediaminetetraacetate with Fe). The ethylenediaminetetraacetic acid and diethylenetriaminepentaacetic acid in the form of salts with sodium, potassium or the like are rather preferable in view of easiness of availability.

When the component (d) is added to the present composition, the setting time to an adherend having been subjected to an antioxidant treatment such as green chromate, colored chromate, bright chromate, and black chromate treatments becomes fast and the adhesive strength becomes slightly strong. Moreover, even when the component (d) is added in a suitable amount as described below, the storage stability does not become worse. With respect to a method of adding the component (d), it is desired to add the component (d) in the composition by previously dissolving it in a hydroxyl group-containing (meth)acrylate or previously dissolving it in water in view of the solubility of the component (d).

The component (d) can be added in an amount of from 0.01 to 2 parts by weight based on 100 parts by weight of the component (a). When the blending amount of (d) is less than 0.01 parts by weight, the effect as a polymerization accelerator may possibly become insufficient. Also, when it exceeds 2 parts by weight, the storage stability of the anaerobic composition may possibly become worse.

In addition to the foregoing component, a component capable of accelerating the polymerization can be added in a small amount into the present composition. Examples of such polymerization accelerators include amine compounds, mercaptan compounds, and hydrazine derivatives. Examples of amine compounds include heterocyclic secondary amines such as 1,2,3,4-tetrahydroquinoline and 1,2,3,4-tetrahydroquinaldine; heterocyclic tertiary amines such as quinoline, methylquinoline, quinaldine, and quinoxalinephenazine; aromatic tertiary amines such as N,N-dimethyl-anisidine and N,N-dimethylaniline; and azole based compounds such as 1,2,4-triazole, oxazole, oxadiazole, thiadiazole, benzotriazole, hydroxybenzotriazole, benzothiazole, benzoxazole, 1,2,3-benzothiadiazole, and 3-mercaptobenzotriazole. Examples of mercaptan compounds include linear mercaptans such as n-dodecyl mercaptan, ethyl mercaptan, and butyl mercaptan. Examples of hydrazine derivatives include ethyl carbazate, N-aminorhodanine, acetylphenylhydrazine, p-nitrophenylhydrazine, and p-trisulfonylhydrazine, but not limited thereto.

In the invention, various additives can be further used. For example, for the sake of obtaining storage stability, radical absorbers such as benzoquinone, hydroquinone, and hydroquinone monomethyl ether can be added. Also, metal chelating agents such as ethylenediaminetetraacetic acid or a disodium salt thereof, oxalic acid, acetylacetone, and o-aminophenol may be added. Besides, for the sake of further adjusting properties of the anaerobic curable resin and properties of a cured product thereof, a thickener, a filler, a plasticizer, a coloring agent, and the like can be used as needed.

In the conventional anaerobic curable compositions, it was difficult to bond an inert metal such as zinc chromate-treated metals, and its adhesive strength was weak, so that it took a long period of time for curing. Even when an adherend is an inert metal, the composition of the invention gives a high curing rate and an enhanced adhesive strength. Moreover, nevertheless the curing rate becomes fast, the composition of the invention is equivalent in the storage stability to the conventional anaerobic curable compositions and can be stored at room temperature over a long period of time.

### EXAMPLES

The invention will be described below in detail in more detail with reference to the following Examples, but the invention should not be construed as being limited thereto. Incidentally, the blending amounts shown in the tables are all given in terms of “parts by weight”.

### Examples 1 to 7 and Comparative Examples 1 and 2

A mixture of 50 parts by weight of 2-hydroxyethyl methacrylate (HEMA) and 50 parts by weight of 2,2-bis[4-(methacryloxyethoxy)phenyl]propane as the component (a), 1 part by weight of cumene hydroperoxide as the component (b), and 1 part by weight of o-benzoic sulfimide as the component (c) was used as a base resin. To 100 parts by weight of the base resin, a copper complex of disodium ethylenediaminetetraacetate (EDTA.2Na.Cu) was added as the component (d) in amounts shown in Table 1, respectively, to prepare anaerobic curable compositions. Each of the resulting compositions was subjected to the following evaluation tests.

Setting Time:

One drop of each of the resulting compositions was coated on a screw part of a bright chromate hexagon coupling bolt of JIS B1180 (M10, P1.5×20 mm), a bright chromate hexagon nut of JIS B1181 was fasten halfway into a part of the bolt at 0 N·m, and the both were allowed to stand at an environment at 25° C. and 40% (temperature and humidity, respectively: the same apply hereinafter), thereby measuring a setting time.

Adhesive Strength:

With respect to the adhesive strength, one drop of each composition was coated on a screw part of a bright chromate hexagon coupling bolt of JIS B1180 (M10, P1.5×20 mm), a bright chromate hexagon nut of JIS B1181 was fasten halfway into a part of the bolt at 0 N·m, and the both were allowed to stand at an environment at 25° C. and 40% for 24 hours. Thereafter, using a torque measuring device, the nut was continuously rotated into the unfastening direction, and the torque at the point when the nut started to move (point of adhesive fracture) was measured.

Storage Stability:

With respect to the evaluation of the storage stability, a gelation test at 80° C. was carried out as a heat accelerating test. Each composition was allowed to stand in a heating furnace at 80° C. for one hour. The composition which then caused gelation to form a gelled product is rated “C”; the composition which caused thickening is rate “B”; and the composition which did not substantially cause thickening is rated “A”, respectively.

The results of the foregoing evaluation tests are shown in Table 1. As can be seen from Table 1, by adding EDTA.2Na.Cu, it is possible to make the setting time fast.

### Examples 8 to 14 and Comparative Examples 3 and 4

Anaerobic curable compositions were prepared in the same manner as in Example 1, except that an iron complex of sodium diethylenetriaminepentaacetate (DTPA.Na.Fe) was added as the component (d) in amounts shown in Table 2, respectively in place of EDTA.2Na.Cu. Each of the resulting compositions was subjected to the evaluation tests in the same manner as in Example 1. The results are shown in Table 2.

TABLE 1

| | | | | | | | | | Comp. | Comp. |
|---|---|---|---|---|---|---|---|---|---|---|
| | | Ex. 1 | Ex. 2 | Ex. 3 | Ex. 4 | Ex. 5 | Ex. 6 | Ex. 7 | Ex. 1 | Ex. 2 |
| Base resin | parts by | 100 | 100 | 100 | 100 | 100 | 100 | 100 | 100 | 100 |
| | weight | | | | | | | | | |
| EDTA.2Na.Cu(II) | parts by | 0.01 | 0.03 | 0.05 | 0.1 | 1.0 | 1.5 | 2.0 | 0 | 3.0 |
| | weight | | | | | | | | | |
| Setting time | min. | 30 | 17 | 15 | 16 | 15 | 15 | 15 | 90 | 15 |
| Adhesive strength | N · m | 17 | 20 | 25 | 25 | 25 | 25 | 25 | 10 | 25 |
| Storage stability | Judgment | A | A | A | A | A | A | B | A | C |

TABLE 2

| | | | | | | | | | Comp. | Comp. |
|---|---|---|---|---|---|---|---|---|---|---|
| | | Ex. 8 | Ex. 9 | Ex. 10 | Ex. 11 | Ex. 12 | Ex. 13 | Ex. 14 | Ex. 3 | Ex. 4 |
| Base resin | parts by | 100 | 100 | 100 | 100 | 100 | 100 | 100 | 100 | 100 |
| | weight | | | | | | | | | |
| DTPA.Na.Fe | parts by | 0.02 | 0.04 | 0.07 | 0.1 | 1.0 | 1.5 | 2.0 | 0 | 3.0 |
| | weight | | | | | | | | | |
| Setting time | min. | 24 | 17 | 14 | 15 | 14 | 14 | 14 | 90 | 11 |
| Adhesive strength | N · m | 20 | 25 | 25 | 25 | 25 | 25 | 25 | 10 | 25 |
| Storage stability | Judgment | A | A | A | A | A | A | B | A | C |

### Examples 15 to 19 and Comparative Example 5

Examples 15 to 19 and Comparative Example 5 were carried out by changing the kind of the metal ion of the EDTA metal complex. With the same formulation as in Example 1, 0.02 parts by weight of the EDTA metal complex was added after dissolving it in 0.2 parts by weight of purified water to make the solubility thereof constant. As the EDTA metal complex, those in which the metal was Mg, Mn, Fe, Ni, or Ca, were used, or one in which the EDTA metal complex was omitted, i.e., only purified water was used.

Each of the resulting compositions was subjected to the evaluation tests in the same manner as in Example 1. With respect to the evaluation of the setting time, however, one drop of each composition was coated on the M10 bolt, the nut was inserted at 0 N·m, and the measurement was carried out every 10 minutes. The evaluation results are shown in Table 3. As can be seen from Table 3, by adding the metal complex of EDTA, the setting time is explicitly improved as compared with the case of not adding the metal complex of EDTA.

TABLE 3

| | | Ex. | Ex. | Ex. | Ex. | Ex. | Comp. |
|---|---|---|---|---|---|---|---|
| | | 15 | 16 | 17 | 18 | 19 | Ex. 5 |
| Base resin | parts by | 100 | 100 | 100 | 100 | 100 | 100 |
| | weight | | | | | | |
| Metal ion in | parts by | Mg | Mn | Fe | Ni | Ca | Only |
| EDTA metal | weight | | | | | | water |
| complex | | | | | | | |
| Setting time | min. | 30 | 30 | 40 | 40 | 30 | 70 |
| Adhesive | N · m | 20 | 20 | 17 | 17 | 25 | 10 |
| strength | | | | | | | |
| Storage | Judgment | A | A | A | A | A | A |
| stability | | | | | | | |

### Comparative Examples 6 to 13

In Comparative Examples 6 to 9, a metal complex of other compounds called chelating agents were added in place of the component (d) of the invention on a basis of the formulation of Example 1, to thereby prepare compositions. In order to make the solubility of 0.02 parts by weight of the metal complex of the chelating agent constant, in the same manner as in Example 15, the metal complex was dissolved in 0.2 parts by weight of purified water and then added to 100 parts by weight of the foregoing base resin. As the metal complex of the chelating agent to be used, a copper complex of nitrilotriacetic acid (NTA), a vanadium complex of hydroethyliminodiacetic acid (HIDA), a copper complex of triethylenetetraminehexaacetic acid (TTHA), and an iron complex of propanediaminetetraacetic acid (PDTA) were used, respectively.

In Comparative Examples 10 to 13, 0.02 parts by weight of an EDTA simple body, a sodium salt of EDTA, a DTPA simple body, or a sodium salt of DTPA was added in place of the complex of the invention, and 0.01 parts by weight of copper oxide was further added on a basis of the formulation of Example 1, to thereby prepare compositions.

Each of the resulting compositions was subjected to the evaluation tests in the same manner as in Example 1. With respect to the setting time, however, the measurement was carried out in the same manner as in Example 15. The evaluation results are shown in Table 4. As can be seen from Table 4, it could be confirmed that with the chelating agents which are not the component (d) of the invention, the effect is not given, and the storage stability is inferior.

TABLE 4

| | | Comp. | Comp. | Comp. | Comp. | Comp. | Comp. | Comp. | Comp. |
|---|---|---|---|---|---|---|---|---|---|
| | | Ex. 6 | Ex. 7 | Ex. 8 | Ex. 9 | Ex. 10 | Ex. 11 | Ex. 12 | Ex. 13 |
| Base resin | parts by | 100 | 100 | 100 | 100 | 100 | 100 | 100 | 100 |
| | weight | | | | | | | | |
| Chelating agent | | NTA | HIDA | TTHA | PDTA | EDTA | EDTA | DTPA | DTPA |
| Metal ion in | | Cu | Va | Cu | Fe | Nil | Na | Nil | Na |
| complex | | | | | | | | | |
| Setting time | min. | 10 | 10 | 80 | 90 | 90 | 120 | 80 | 100 |
| Adhesive | N · m | 5 | 5 | 5 | 5 | 10 | 10 | 10 | 10 |
| strength | | | | | | | | | |
| Storage stability | Judgment | C | C | A | A | C | A | C | C |

While the invention has been described in detail and with reference to specific embodiments thereof, it will be apparent to one skilled in the art that various changes and modifications can be made therein without departing from the spirit and scope thereof.

This application is based on a Japanese patent application filed Jul. 25, 2003 (Japanese Patent Application No. 2003-279578) and a Japanese patent application filed Oct. 28, 2003 (Japanese Patent Application No. 2003-366853), the contents thereof being herein incorporated by reference.

### INDUSTRIAL APPLICABILITY

The anaerobic curable composition of the invention can be rapidly cured even in the case where an adherend is an inert metal and is suitable for bonding or fixing of screws, bolts, etc., fastening of fitting parts, bonding or sealing between flange planes, and the like.

What is claimed is:

1. An anaerobic curable composition comprising:
(a) a compound having at least one radically polymerizable functional group in its molecule thereof;
(b) an organic peroxide;
(c) o-benzoic sulfimide; and
(d) a complex of a metal other than alkali metals and ethylenediaminetetraacetic acid, or a complex of a metal other than alkali metals and diethylenetriaminepentaacetic acid.

2. The anaerobic curable composition according to claim 1, wherein
the component (b) is contained in an amount of from 0.1 to 5 parts by weight,
the component (c) is contained in an amount of from 0.1 to 5 parts by weight, and
the component (d) is contained in an amount of from 0.01 to 2 parts by weight, each based on 100 parts by weight of the component (a).

3. The anaerobic curable composition according to claim 1 or 2,
wherein the metal other than alkali metals is selected from the group consisting of Mg, Ca, Ti, V, Cr, Mn, Fe, Co, Ni, Cu, Zn, Al, and Ag.
